(19) United States
(12) Patent Application Publication
(10) Pub. No.: US 2007/0134639 A1
(43) Pub. Date: Jun. 14, 2007

(54) Simulation process with user-defined factors for interactive user training

(76) Inventors: Jason Sada, Scottsdale, AZ (US); Ryan Holmes, Phoenix, AZ (US); Russell Stimpson, Mesa, AZ (US)

Correspondence Address: ETHERTON LAW GROUP, LLC, 5555 E. VAN BUREN STREET, SUITE 100, PHOENIX, AZ, 85008, US

(21) Appl. No.: 11/300,154

(22) Filed: Dec. 13, 2005

(51) Int. Cl. G09B 7/00

(52) U.S. Cl. 434/323

(57) ABSTRACT

A process for modeling and graphically simulating a real environment in order to train a user to obtain a desired performance. This process enables the user to input model parameters from real events to simulate the real event, to interact with the system, and to track the results. The process uses factors, one of which is the user, to simulate real scenarios. Each factor is defined by parameters and data from the real event. All factors are input prior to the simulation; the user's event data is input automatically as the user reacts to the other factors' actions during the simulation. The system tracks the user's performance and compares it to what happened in the real event. This system has particular application to training the user to respond properly in real situations, such as sporting events, medical emergencies, military missions, and casino gaming.

### FIELD OF INVENTION

This invention relates to processes for modeling and graphically simulating an environment in order to train a user to obtain a desired performance. This invention relates particularly to process that enables the user to input model parameters from real events for simulating a realistic event, to interact with the system, analyze characteristics of the events and to track the results. It has particular application to training the user to respond properly in real situations, such as sporting events, medical emergencies, military missions, and casino gaming.

### BACKGROUND

Simulation is a powerful tool for analyzing, designing, and operating complex systems. Early simulation mechanism used paper flow charts to diagram processes. The advent of computer technology has radically changed simulations, and now software is commercially available that, with proper data input, can render realistic three-dimensional simulations of real environments.

Video games have been early adopters of realistic three-dimensional simulations, followed closely by training applications. However, one disadvantage of video games is that the simulated environment is not real to the user. Beyond fantasy simulations on alien planets, even terrestrial football video games use data that reflect events that the user will never act in, such as past SuperBowl championships.

It would be desirable to provide a three-dimensional simulation that utilizes data from events that are personal to the user and that the user will eventually act in. These simulations would be particularly useful for training the user to respond properly in real situations, such as sporting events, medical emergencies, military missions, and casino gaming.

### SUMMARY OF THE INVENTION

The present invention is a process for modeling and graphically representing and simulating a real environment in order to train a user to obtain a desired performance and assist expert in evaluating tendencies. This process enables the user to input parameters from real events to simulate the real event, to interact with the simulation, and to track the results and compare them to the desired result. The process uses factors, one of which is the user, to model real scenarios. Each factor is defined by parameters and event data from the real event. The factors interact in a specific scenario, which may be segmented into several stages occurring over a period of time. Each of the factors has a specific assignment that it executes in each stage. All factors are input prior to the scenario simulation. The user then interacts with the scenario, and the user's event data is input automatically as the user reacts to the other factors' actions during the simulation. The system tracks the user's performance and compares it to the desired performance in the real event. In the preferred embodiment, the user's performance is scored. This system has particular application to training the user to respond properly in real situations, such as sporting events, medical emergencies, military missions, and casino gaming.

### BRIEF DESCRIPTION OF THE DRAWINGS

FIG. 1 is a schematic illustration of the computer, display and input devices;

FIG. 2 is a flow diagram illustrating the preferred embodiment of the present method;

FIG. 3 is a screen capture from the display showing a specific scenario created with event data;

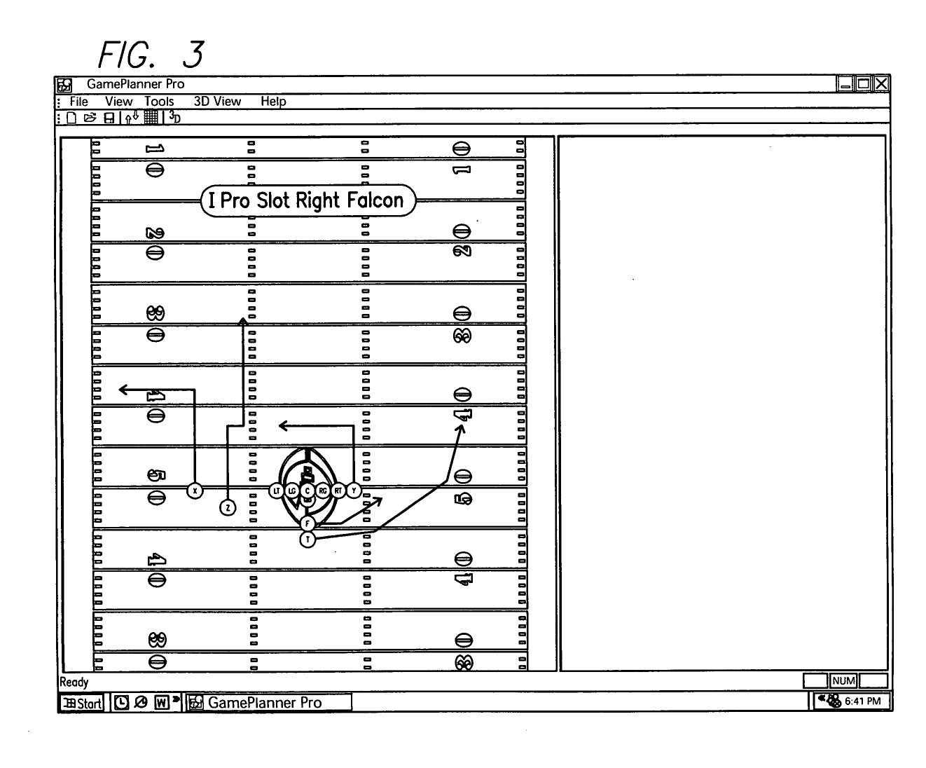

FIG. 4 is a screen capture from the display showing a different instance of the scenario of FIG. 3;

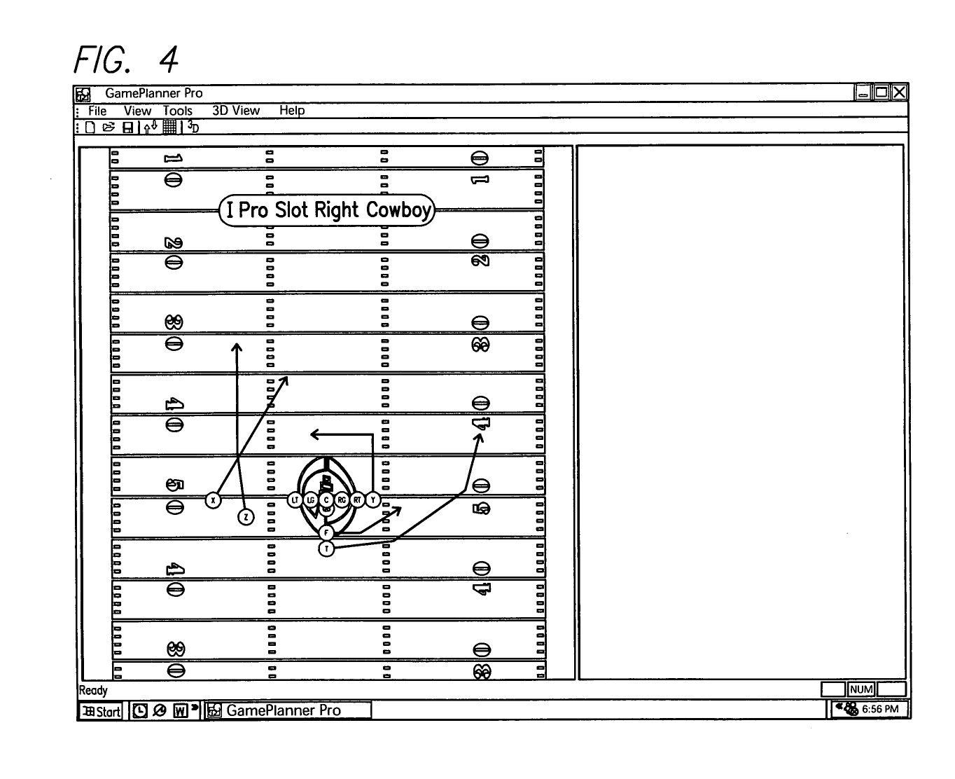

FIG. 5 is a hit table.

FIG. 6 is a graphical representation of the data in the hit table of FIG. 5.

FIG. 7 is a screen capture from the display showing a simulation of the scenario of FIG. 3 and the text message box for coaches' reminders;

FIG. 8 is a screen capture from the display showing a simulation of the scenario of FIG. 3 and a test question for the user.

FIG. 9 is a screen capture of the scenarios selected in bulk and displayed within the print manager.

### DETAILED DESCRIPTION OF THE INVENTION

The present invention is a system that uses modeling, simulation, interaction, and tracking to train a user to obtain a desired performance. The system models a real environment in which a person interacts with other factors to create an event with a specific outcome. The user can practice taking certain actions in the simulated environment that mimic those that were successful in the real event and thereby be trained how to respond to the situation to achieve the specific outcome. The process allows the user to plan desired actions from real event data, learn the effects of the desired actions by repeated viewing of the real event data, and executing responses to the real event data.

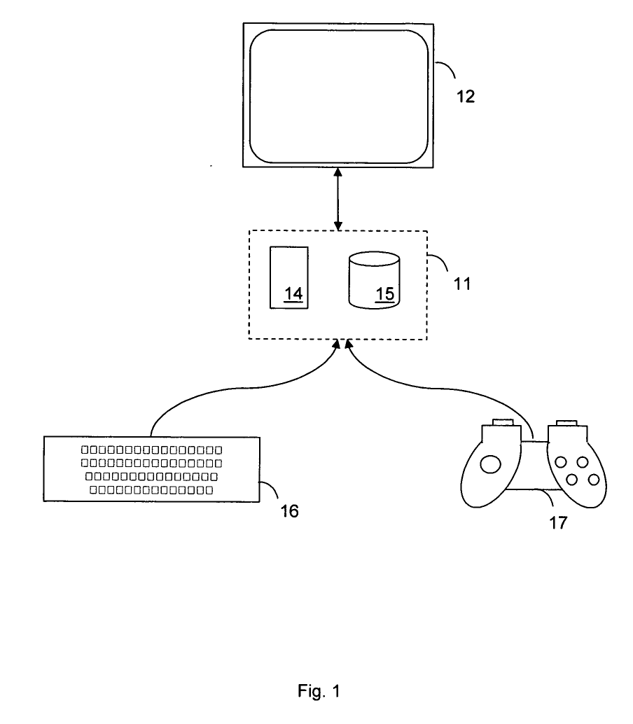

The system is implemented on a computer 11 having a data processor 14 and memory 15, with a display 12 and one or more data entry devices. See FIG. 1. Preferably the data processor is powerful enough to execute three-dimensional graphics operations quickly enough for the display to happen as fast as the event does in real time. Preferably the data input devices is a game controller, preferably a gamepad 17, such as those known for video games, with buttons that generate signals to the computer in response to user input to indicate direction, speed, acceleration and action. The device may also include a separate data input device for entering data about the real event, such as a keyboard 16, a touchscreen, or a port for downloading pre-formatted event data.

Throughout this specification, a football game is used as the exemplary embodiment. However, the present system can be implemented for many types of events such as business training including stock trading, business ethics, management training, and start-up business training; manufacturing training including production process training, shop floor management, and equipment maintenance; security, police, and military training; medical training including first aid, surgery, pharmacist process training, and patient evaluation training; emergency response training including crowd control and evacuation procedures; driving training and traffic control; and casino management such as how to run a floor, table procedures, and security tracking; and other sports such as basketball, baseball, soccer, hockey, and tennis.

The real event is modeled by identifying as many factors as practicable that affect the outcome of the event. The factors are modeled by describing one or more of their attributes and inputting event data that represents that attribute in the real event 22. For example, an entire football game can be modeled, or planned, using players and the field as the factors. The players can be defined by assigning personal characteristics. Formations are defined by assigning each player a position and a field location. Plays are defined by assigning routes to one or more players in a formation. Gameplans are created by combining a number of plays.

In the preferred embodiment of this invention, the user inputs the following factors and their attributes into the computer. For the offense, the plays are defined by which players are on the field; each player's position (e.g. quarterback, tight end), location on the field, stance, route or assignment, set progression (for the quarterback), pre- and post-snap motion, and backfield motion, as applicable for the player's position. For the defense, the plays are defined by the players on the field, each player's position, location on the field, stance, coverage or player assignment, if any, and pre- and post-snap motion, if any. Each of these factors and their attributes can be customized to a given event.

Data representing real instances of each of the attributes is entered into the system. For example, a formation used by an NFL football team, herein called the I Pro Right Slot, requires the following players on the field: quarterback, center, left guard, right guard, left tackle, right tackle, tight end, two running backs and two receivers. All players are assigned certain attributes, namely the position on the field. To form a specific play using that formation, additional attributes are assigned, namely the routes of each player and their stances. For example, center, left guard, right guard, left tackle, right tackle are each assigned a three-point stance and to pass block. The tight end is assigned a three point stance and a 5 yard in route. One running back is assigned pre-snap motion to the right and the other is assigned an 8 yard hook outside to the right. One receiver is assigned a 12 yard out pattern to the left and the other and another is a fly route. Assignments are shown in FIG. 1. This play is referred to herein as the I Pro Right Slot Falcon. The players can be further defined by personal characteristics such as height; weight, skin color, hair color, player number, speed or acceleration. The teams can be defined as home or away, and the uniform color and style can be defined.

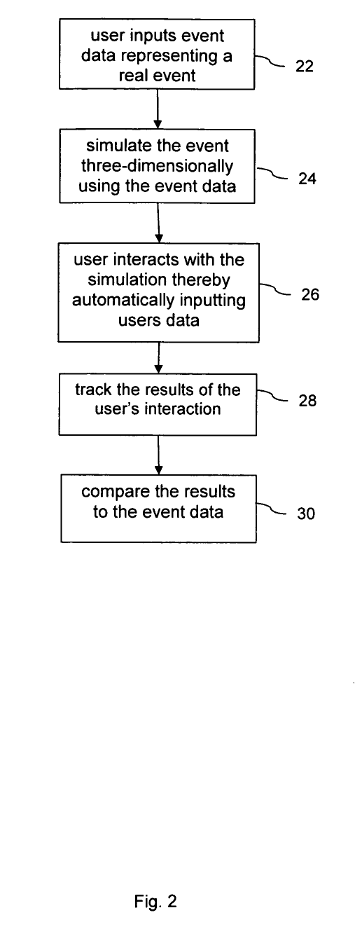

The software modeling program is preferably written in a scripting language such as C++ and produces a graphical user interface that displays graphical icons and menus to make setting the attributes relatively easy. Once a formation is input, the formation can be saved in memory and a series of plays based on that formation can be made with simple variations in on ore more of the attributes. For example, if the receivers' routes in the I Pro Right Slot Falcon, described above, are changed so that the receiver with the 12 yard out pattern is instead assigned to a slant down the middle, a new play is created. This play is saved and called the I Pro Right Slot Cowboy. See FIG. 2.

The user enters real data for each of the factors and their attributes and continues until he user sufficient data is entered for a real scenario to be simulated. For single plays and simple training, relatively little data needs to be entered. However, for more complex scenarios, such as a full gameplan or a crowd control at a political protest rally, significantly more data is entered. Typically the event data is entered by the user using an input device such as a keyboard, but the data may also be entered in bulk. For example, the data can be imported from a spreadsheet containing desired and possibly undesired data. The system applies a filter to extract and intake the desired information from the spreadsheet, filtering out the undesired data. The statistics describing the factors can be input or calculated by the system from the input data.

The real event is simulated in three-dimensions using the event data 24. Preferably the simulation uses sophisticated rendering software, such as DirectX, to evoke a realistic three-dimensional environment. Preferably the environment can be seen from multiple points of view. For example, in the football game, the formations can be viewed in three-dimensions from on high (near the top of the stadium), from a mid-height (about goal post crossbar height), from shoulder height behind the quarterback, an in-helmet view, and a view that allows custom zoom and rotation. Preferably the parameters of the view, such as the distance from the players and distance from the field, can be customized. The simulation can be stopped and started by the user by inputting instructions through the gamepad. Viewing the simulations enables a user to learn the effects of the desired actions by repeated viewing of the real event data.

The scenario can be segmented into stages representing specific processes or periods of time. For example, in the football game, a scenario may pit an offensive play against a defensive play. The first stage is the huddle; followed by a down stage moving into formation; followed by the motion stage prior to the snap when the quarterback reads the defensive formation and make appropriate calls; followed by the snap and the stage after snap when the quarterback reads the progression and defensive coverages. In the preferred embodiment, the user can stop and start the scenario at each stage using the gamepad.

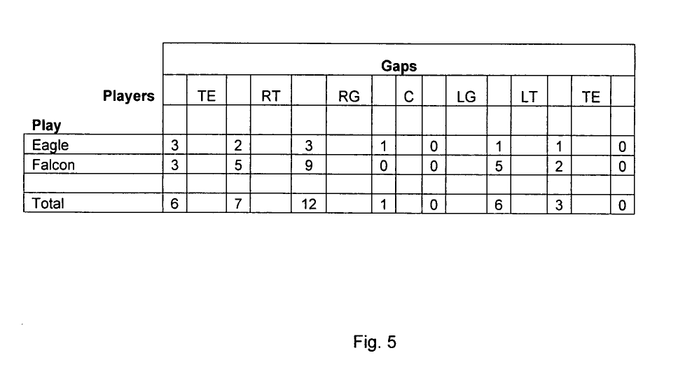

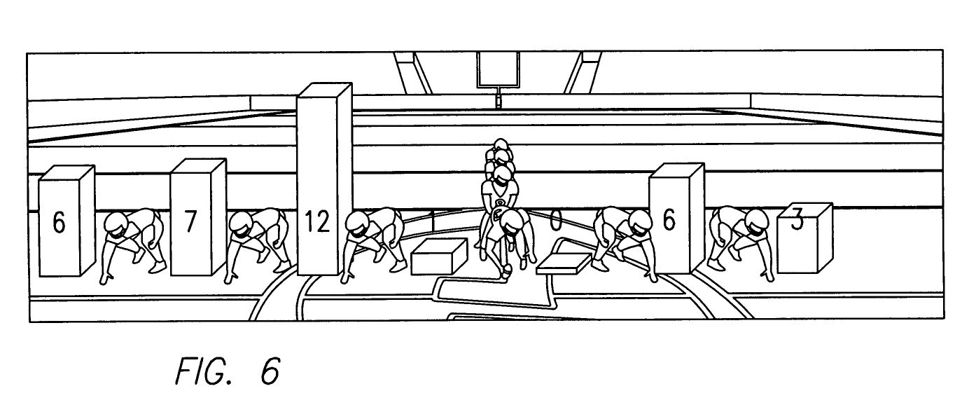

In another embodiment, a user can view the aggregate statistics for a series of real events to determine the tendencies or trends thereof. For example, in the football game the opponent may run a number of run plays, where the ball carrier runs in the gap between two of the other offensive players. The number of times each gap is entered, or hit, by the ball carrier is recorded. Conventionally these instances are recorded in a hit chart. For example, the table in FIG. 5 collates the hit data from two running plays named Eagle and Falcon. The present invention graphically displays the data from the hit chart so that the user can more easily learn the tendencies in the event from the real event data. See FIG. 6. which shows the hits in a bar chart from the perspective of the middle linebacker. This will enable the user to have a more successful response when the user is presented with a scenario in real time that he has not seen before in training. The graphical hit chart can be provided from the perspective of any player.

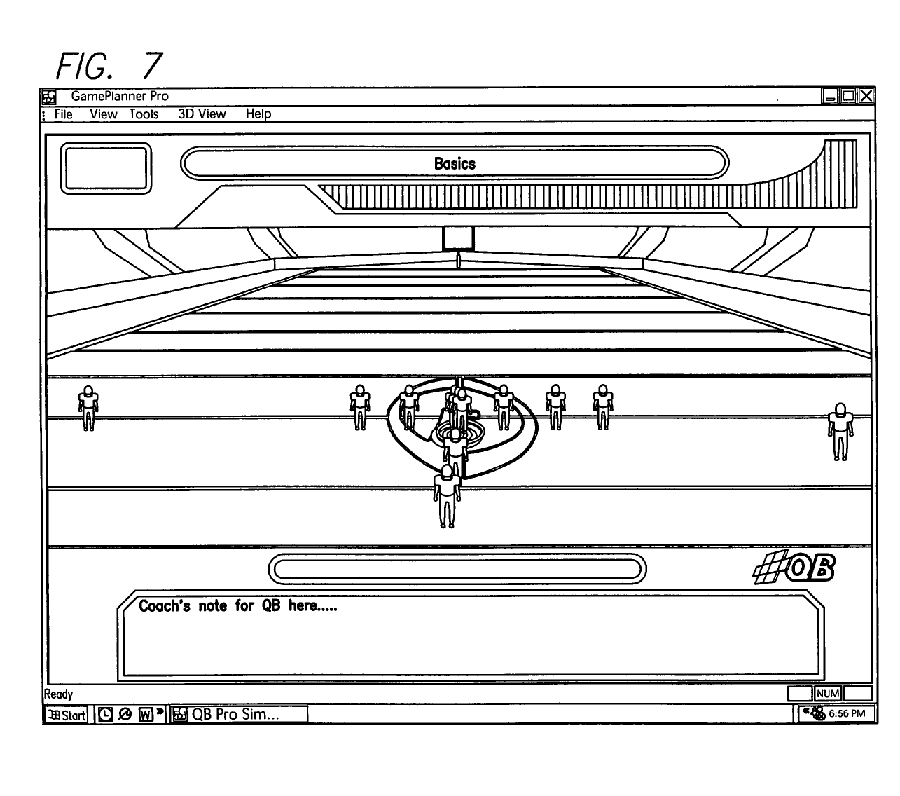

In addition to displaying the event simulation, the simulation also displays text information 51 for the user. For example, a coach can enter reminders to a user about specific aspects of his game that need to be improved. See FIG. 7.

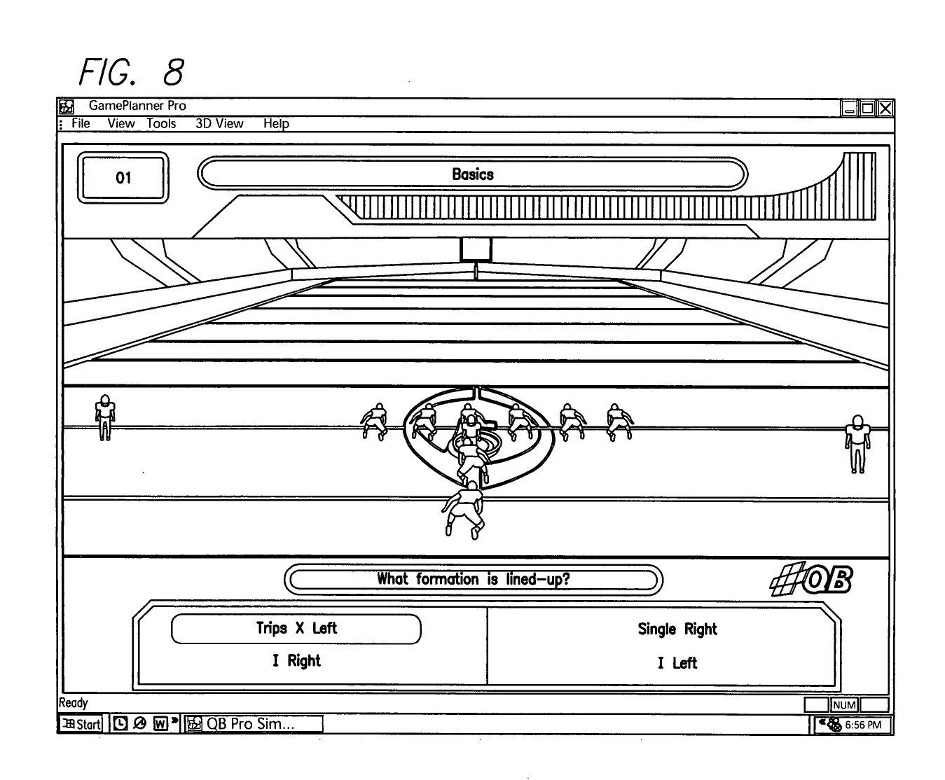

One aspect of training the user is to test the user's analysis of the given scenario and his response to the real event data. For example, a quarterback in a football game needs to be able to quickly determine whether the offense has lined up in the formation he called in the huddle. In the football example where the user is the quarterback, the program queries 61 the quarterback at the snap stage as to which offensive formation is lined up. See FIG. 8. Similarly, the program can query the user about other aspects that a good quarterback needs to be aware of, such as the defensive formation, calling variables at the line of scrimmage prior to the snap, and progression reads checking-off receivers and reading defensive coverage after snap. The user responds to the queries via the gamepad by entering a text response, highlighting the appropriate object in the displayed image, or providing a graphical indication of the response. The responses are compared and the user judged on his performance, as described in more detail below.

The user can run the scenario in modes of increasing difficulty. The same scenario can be run at different speeds, with or without the opposing team in the scenario, and with or without assistance in the form of hints displayed as text or graphics. For example, in the basic level of quarterback training, the user can run the scenario in assisted mode without showing the defensive players on the display. The computer graphically displays a circle on the field to indicate to the user the position he must direct the simulated quarterback to on the field prior to the snap. When the formation stage is executed, the user uses the gamepad to instruct the simulated quarterback to move to a position behind the center. If the user moves into the proper position fast enough, the user performed as desired. Similarly, the computer can graphically indicate with a numeral over the head of the receiver the progression of the reads through the receivers. When the after-snap stage is executed, the user uses the gamepad to instruct the simulated quarterback to view each of the receivers in series. If the user causes the simulated quarterback to view the receivers in the proper order and fast enough, the user performed as desired.

In a more difficult mode, the user executes the scenario without assistance. In a yet a more difficult mode, the scenario is executed without assistance and the defensive players are shown on the display. The simulated event may be run in real time to best simulate real-world conditions.

In a testing mode, the users' actions are compared to a desired performance. As the user is better trained, his performance is closer to the desired performance. The performance can be scored in any number of ways, for any number of criteria including proper analysis of the situation, proper choice of action, adequate response time, etc. Each test may have a number of scenarios. The scenarios can vary from easy to difficult, each can run fast or slow, or the pace between the scenarios can run fast or slow.

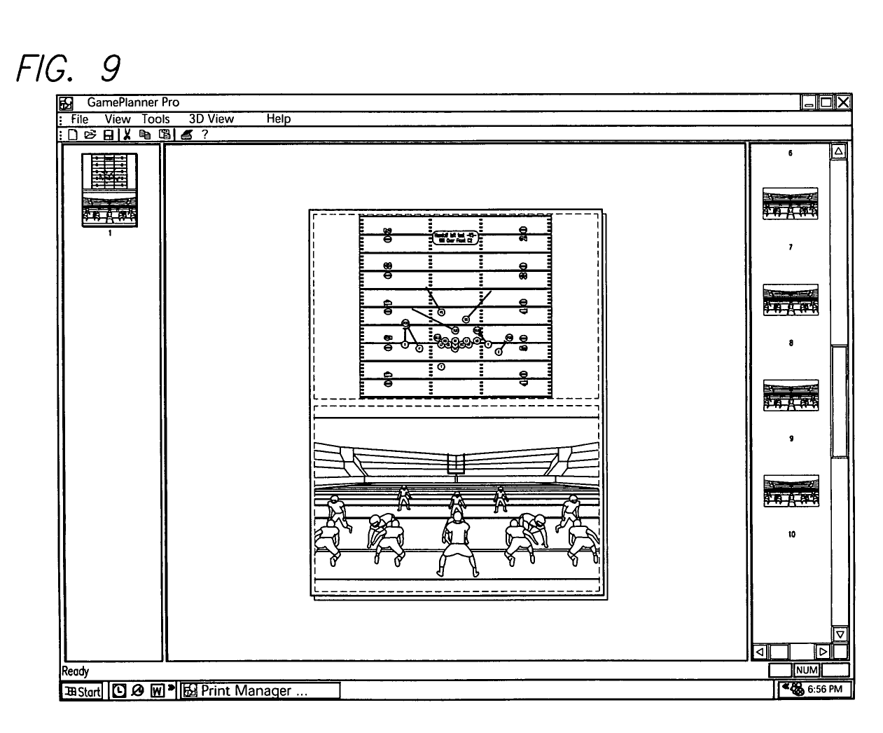

To more effectively communicate the simulations, the system enables the user to select all scenarios at one time—or a desired subset thereof—and prepare the data for printing. The bulk selection is preferably implanted with a scripter. Once selected, the images can be manipulated in a print manager, which enables the user to define which views are presented, change the order of the images, add text, delete unwanted images, etc. Each image can be manipulated separately, or a desired characteristic can be applied to every image in the bulk selection. For example, if the images in the print manager are displayed from the quarterback's perspective, in one action affecting all images the user can change the display to show all images from the perspective of the right tackle, without having to change the display on each image. See FIG. 9, which shows screen capture of the scenarios selected in bulk and displayed within the print manager.

While there has been illustrated and described what is at present considered to be a preferred embodiment of the present invention, it will be understood by those skilled in the art that various changes and modifications may be made, and equivalents may be substituted for elements thereof without departing from the true scope of the invention. Therefore, it is intended that this invention not be limited to the particular embodiment disclosed as the best mode contemplated for carrying out the invention, but that the invention will include all embodiments falling within the scope of the appended claims.

I claim:

1. A process for training a user to respond properly to a real event comprising:
a) enabling the user to input event data representing a real event, wherein the event data comprises two or more factors having attributes assigned by the user; and
b) providing a three-dimensional simulation of the event using the event data, wherein the simulation comprises one or more scenarios, each having one or more stages in which each factor has one or more assignments.

2. The process of claim 1 further comprising:
a) enabling the user to interact with the simulation thereby inputting user's data automatically as the user reacts to the event data during the simulation;
b) tracking the results of the interaction; and
c) comparing the results to the event data to determine whether the user performed as desired.

3. The process of claim 1 further comprising:
a) querying the user with text regarding the user's desired performance in the scenario.

4. The process of claim 1 further comprising:
a) providing to the user graphical indication to assist the user in obtaining the user's desired performance in the scenario.

5. The process of claim 2 further comprising:
a) querying the user with text regarding the user's desired performance in the scenario.

6. The process of claim 2 further comprising:
a) providing to the user graphical indication to assist the user in obtaining the user's desired performance in the scenario

7. The process of claim 6 wherein the user can respond to the querying by entering a text response, highlighting the appropriate object in the displayed image, or providing a graphical indication of the response.

8. The process of claim 1 wherein the attributes are collated and displayed to show one or more tendencies.

9. The process of claim 1 wherein the three-dimensional simulation is visual.

10. The process of claim 1 wherein the three-dimensional simulation is displayed in a series of images and the series of images are manipulated in bulk.

11. The process of claim 1 wherein the event is a football play and the factors comprise a football field and a plurality of players, wherein the user inputs event data to assign each of the players one or more of the following attributes:
a) position;
b) position on the field;
c) route;
d) coverage;
e) stance;
f) height;
g) weight;
h) speed; or
i) acceleration.

12. The process of claim 11 wherein:
a) the players comprise a plurality of offensive players and a plurality of defensive players;
b) the user inputs event data to define at least one offensive formation wherein the user:
i. assigns each offensive player a position, and one of the offensive players is assigned the quarterback position; and
ii. assigns a location on the field to each offensive player;
c) the user inputs event data to define at least one defensive formation wherein the user:
i. assigns each defensive player a position; and
ii. assigns a location on the field to each defensive player.

13. The process of claim 12 wherein:
a) the user inputs event data to the offensive formation to assign routes to a plurality of offensive players thereby forming an offensive play; and
b) the user inputs event data to the defensive formation to assign coverages to a plurality of defensive players thereby forming a defensive play;
wherein the simulation pits the offensive play against the defensive play, thereby forming a scenario.

14. The process of claim 13 further comprising:
a) forming additional scenarios by repeating the process of claim 6;
b) displaying the scenarios in series to simulate a game.

15. The process of claim 1 wherein the user interacts with the simulation using a game controller.

16. An apparatus for simulating a user's response to a real event comprising:
a) an input device enabling the user to input event data representing the real event wherein the event data comprises two or more factors having attributes assigned by the user;
b) an input device configured to input user data representing the user's actions;
c) a data processing unit connected to the input devices, the data processing unit including:
i. a modeling process that processes event data to model a real event; and
ii. a simulation process that processes user data to display the user's actions in the simulated environment wherein the simulation comprises one or more scenarios, each having one or more stages in which each factor has one or more assignments;
iii. a tracking process that tracks the user's actions in the simulated environment;
iv. a comparison process that compares the user's actions to the outcome of the real event;
v. a query process that queries the user with text regarding the user's desired performance in the scenario.
d) a visual display that presents the text and a simulated view of user's actions in the simulated environment.

17. The apparatus of claim 16 wherein the data processing unit further comprises:
a) an assistance process for providing to the user graphical or text-based indication of the user's desired performance in the scenario.

18. The apparatus of claim 16 wherein:
a) the event is a football play and the factors comprise a football field and a plurality of players.
